(19) United States
(12) Patent Application Publication
(10) Pub. No.: US 2017/0190629 A1
(43) Pub. Date: Jul. 6, 2017

(54) PROCESS FOR FABRICATING CARBON-CARBON COMPOSITES

(71) Applicant: BLUE CUBE IP LLC, Midland, MI (US)

(72) Inventors: Hamed LAKROUT, Lake Jackson, TX (US); Maurice J. MARKS, Lake Jackson, TX (US); Ludovic VALETTE, Perrysburg, OH (US); Lameck BANDA, Manvel, TX (US)

(21) Appl. No.: 15/129,088

(22) PCT Filed: Mar. 9, 2015
(86) PCT No.: PCT/US2015/019442

§ 371 Date: Sep. 26, 2016

Related U.S. Application Data
(60) Provisional application No. 61/970,956, filed on Mar. 27, 2014.

(51) Int. Cl. C04B 35/83; C04B 35/64

(52) U.S. Cl. CPC C04B 35/83; C04B 35/64; C04B 2235/422; C04B 2235/5248; C04B 2235/48; C04B 2235/616; C04B 2235/614; C04B 2235/656; C04B 2235/77; F16D 69/023

(57) ABSTRACT

A process for fabricating a carbon-carbon composite article including the steps of: (a) providing a liquid carbon precursor composition; wherein the liquid precursor composition has a neat viscosity of less than about 10,000 mPa-s at 25° C. prior to adding optional components, prior to curing, and prior to carbonizing; and wherein the liquid precursor composition being cured has a carbon yield of at least about 35 weight percent as measured in the absence of optional components; (b) providing a fibrous or a porous carbon material adapted for being infused with the liquid carbon precursor composition of step (a); (c) infusing the fibrous or porous carbon material of step (b), at least one time, with the liquid carbon precursor composition of step (a) to form a liquid carbon precursor-infused preform; (d) heating the liquid carbon precursor-infused preform of step (c) to form a carbon-carbon composite preform; and (e) increasing the density of the carbon-carbon composite preform of step (d) to form a carbon-carbon composite article.

### FIELD

The present invention relates to a process for fabricating carbon-carbon composites.

### BACKGROUND

Carbon-carbon composites are known to be useful for end use applications such as thermal insulation, structural materials for aircraft and spacecraft and as friction materials for brakes in automobiles, trucks, and aircraft. Carbon-carbon composites are well-suited for structural applications at high temperatures such as conveyor belts of hot molded glass bottles; or for applications where thermal shock resistance and/or a low coefficient of thermal expansion is needed. Carbon-carbon composites can provide excellent performance as friction materials because the carbon-carbon composites exhibit beneficial properties such as high thermal conductivity, large heat capacity, excellent friction characteristics, and excellent wear characteristics.

Carbon-carbon composites are typically made in three stages. First, material is laid up in its intended final shape, with carbon filament and/or cloth reinforcement surrounded by an organic binder such as polymeric materials or pitch. Often, coke or some other fine carbon aggregate such as graphite powder is added to the binder mixture. Second, the lay-up is heated, so that pyrolysis transforms the binder to carbon. The binder loses volume in the process, so that voids form; the addition of aggregate reduces this problem, but does not eliminate the problem. Third, the voids are gradually filled by forcing a carbon-forming gas such as methane or acetylene through the material at a high temperature, over the course of several days. Voids can also be filled with a resin system that is cured in situ and subsequently carbonized at elevated temperatures. This long heat treatment process also allows the carbon to form into several types of allotropes including for example graphite, graphene, diamond, or mixtures thereof.

Heretofore, several processes have been disclosed for preparing various carbonized end products from carbonaceous precursor materials. The known processes for preparing carbonized end products are generally carried out by the steps of: (i) introducing, for example by infusion, impregnation, or infiltration, a liquid carbon precursor into the pores of a porous object or preform (e.g., a carbon reinforcing material such as a bundle of carbon fibers) to form an infused preform, (ii) solidifying (e.g., by curing to form a thermoset) the liquid carbon precursor infused preform to form a solidified preform, and (iii) carbonizing the solidified preform to form a carbonized end product.

The above methods have heretofore been used in combination with other processes to introduce onto the surface of a carbon body or into the pores of a carbon body a liquid carbon precursor or resin to ultimately provide a carbon-carbon composite material. For example, U.S. Pat. No. 7,700,014 B2 discloses a method for manufacturing dense carbon-carbon composite material including the steps of: (1) infiltrating a fibrous preform with pitch to form pitch-infiltrated preform; (2) carbonizing the pitch-infiltrated preform; (3) injecting resin or pitch into the preform in a mold; (4) oxygen stabilizing the filled preform; (5) carbonizing and heat-treating the oxygen-stabilized impregnated preform; and (6) subjecting the preform to a single final cycle of chemical vapor deposition.

WO 01/68556 A1 discloses a method and apparatus for forming fiber-reinforced composite parts. More specifically, WO 01/68556 A1 discloses a method and apparatus for combining raw fibrous and binding materials in a single mixing step followed by consolidation so as to greatly shorten the overall cycle time to a finished fiber-reinforced composite part.

Delhaes, Carbon 2002; 40: 641-657, presents a review regarding chemical vapor deposition and infiltration processes of carbon materials. The review is based on an analysis of the different types of reactors, of the composite materials with different types of pyrocarbon as matrices and a comparison between different processes.

Golecki, Materials Science and Engineering 1997; R20: 37-124, presents another detailed review of producing materials with desired properties utilizing techniques such as inductively-heated thermal gradient isobaric chemical vapor infiltration (CVI), radiantly-heated isothermal and thermal-gradient forced-flow CVI, liquid-immersion, thermal-gradient CVI, and plasma-enhanced CVI. Different heating methods, such as radiative and inductive, and both hot-wall reactors and cold-wall reactors are also compared in the above reference.

U.S. Pat. No. 6,537,470 B1 discloses a process to rapidly densify high temperature materials including carbon-carbon composites and porous preforms with a high viscosity resin or pitch by using a resin transfer molding technique.

Tikhomirov et al., Carbon 2011; 49: 147-153, disclose applying a chemical vapor infiltration technique to exfoliated graphite and then using the resulting graphite to produce carbon-carbon composites. The above reference discusses the use of two different exfoliated graphites compacted to densities of 0.05-0.4 g/cm³ as preforms, and the influence of synthesis conditions (such as temperature, pressure, and/or time) on (1) the degree of infiltration, (2) the pyrolytic carbon morphology, and (3) the carbon-carbon composite characteristics as examined using Raman spectroscopy, scanning electron microscopy and low-temperature nitrogen adsorption.

U.S. Patent Application Publication No. 2011/0195182 A1 discloses using precise sequences of process steps to reduce the capital and material costs that are associated with pitch densification of mesophase (high char-yield) pitches into carbon-carbon composites using RTM. In addition the above patent application publication discusses densification of mesophase pitches into carbon-carbon composites using chemical vapor deposition (CVD) and/or CVI. More specifically the above patent application publication teaches the use of vacuum pitch infiltration (VPI) and resin transfer molding (RTM) processing steps to densify carbon-carbon composites with isotropic (low to medium char-yield) pitches obtained from coal tar, petroleum, or synthetic feedstock.

However, the above various CVD/CVI processes suffer several disadvantages including that the processes are highly capital intensive and suffer from long cycle times with multiple densification cycles typically taking several weeks to complete.

### SUMMARY

A general aspect of the present invention relates to a process for fabricating carbon-carbon composites by first providing a liquid carbon precursor and a fibrous or a porous carbon material; and then infusing the fibrous or a porous carbon material with the liquid carbon precursor to form a liquid carbon precursor-infused preform. The liquid carbon precursor-infused preform is then processed to form a carbon-carbon composite preform followed by subjecting the carbon-carbon composite preform to at least one cycle of chemical vapor deposition and/or at least one cycle of chemical vapor infiltration to increase the density of the carbon-carbon composite preform and form a carbon-carbon composite article.

The present invention includes various processes for the fabrication of carbon-carbon composites including for example, one preferred embodiment of the present invention includes a process for fabricating a carbon-carbon composite including the steps of:

(a) providing a liquid carbon precursor composition; wherein the liquid precursor composition has a neat viscosity of less than about 10,000 mPa-s at 25° C. prior to adding optional components, prior to curing, and prior to carbonizing; and wherein the liquid precursor composition being cured has a carbon yield of at least about 35 weight percent (wt. %) as measured in the absence of optional components;

(b) providing a fibrous or a porous carbon material adapted for being infused with the liquid carbon precursor composition of step (a);

(c) infusing the fibrous or porous carbon material of step (b), at least one time, with the liquid carbon precursor composition of step (a) to form an liquid carbon precursor-infused preform;

(d) heating the liquid carbon precursor-infused preform of step (c) to form a carbon-carbon composite preform; and

(e) increasing the density of the carbon-carbon composite preform of step (d) to form a carbon-carbon composite article.

### DETAILED DESCRIPTION

### Definitions

A “liquid carbon precursor composition” herein means a liquid composition which upon heating forms carbon.

“Densification”, “densify” or “densifying” herein means increasing the ratio weight by volume.

“Solvent” means either (i) a material that will not participate to the crosslinked polymeric network once the article is fully cured or (ii) a low viscosity diluent with low boiling point.

“Solvent-free” or “solvent-less” herein means no significant addition of solvent in a material.

“Carbon material” herein means a carbon-rich material.

“Carbon-carbon composite” herein means the result of the combination of two carbonaceous materials usually a solid phase such as fibers or coal and a diffuse phase such as a vaporized precursor or an infused liquid resin.

“Carbon yield” with reference to a carbonized composition herein means the percent weight remaining from a fully cured sample treated at 10° C./minute from 25° C. to 900° C. under nitrogen.

“Fully cured” with reference to a solidified composition herein means a sample of a composition treated such that there is no soluble fraction that can be extracted from the sample by a solvent.

“Pyrolysis” or “pyrolysizing” herein means heating at temperatures above 600° C. under an inert atmosphere.

“Carbonizing” herein means removing a significant portion of non carbon materials.

“Wetting” herein means affinity between a liquid and a surface translating into the ability of the liquid to spread on the surface.

“Porosity” here means lack of internal continuity of a piece of material.

“Neat viscosity” herein means a viscosity measured in the absence of a solvent.

In its broadest scope, the present invention is directed to a process for fabricating a carbon-carbon composite wherein the process utilizes for example (1) a liquid carbon precursor composition, (2) a fibrous or a porous carbon material, (3) an infusion process step/technique to infuse the fibrous or porous carbon material with the liquid carbon precursor composition to form an liquid carbon precursor-infused preform, (4) a heat treatment process step/technique to convert the liquid carbon precursor-infused preform to a carbon-carbon composite preform; and (5) a process step/technique for increasing the density of the carbon-carbon composite preform to ultimately form a carbon-carbon composite article.

The process of the present invention includes a first step of providing a low viscosity liquid carbon precursor composition useful for manufacturing carbon-carbon composites. For example, in one preferred embodiment, the liquid carbon precursor useful in the present invention can be a liquid carbon precursor composition described in U.S. Provisional Patent Application Ser. No. 61/660,417, filed Jun. 15, 2012, by Lakrout et al. (Attorney Docket No. 72593), and incorporated herein by reference. The process of preparing the liquid carbon precursor composition is also discussed in U.S. Provisional Patent Application Ser. No. 61/660,417, incorporated herein by reference.

In one embodiment, the liquid carbon precursor composition described in the above patent application can include for example a curable liquid carbon precursor composition comprising a combination of: (A) at least one aromatic epoxy resin; and (B)(i) at least one aromatic co-reactive curing agent, or (B)(ii) at least one catalytic curing agent, or (B)(iii) a mixture thereof. The process for preparing the above curable liquid carbon precursor composition includes, for example, producing a curable high carbon yield low neat viscosity resin formulation or composition by admixing (A) at least one aromatic epoxy resin; and (B)(i) at least one aromatic co-reactive curing agent, (B)(ii) at least one catalytic curing agent, or (B)(iii) a mixture thereof; and (C) optionally, at least one cure catalyst or other optional ingredients as desired.

In the above liquid carbon precursor composition of the present invention, the at least one aromatic epoxy resin can be a combination of two or more epoxy compounds wherein at least one of the epoxy compounds is an aromatic epoxy resin. The aromatic epoxy resins useful in the present invention include, for example, the glycidyl ethers of polyhydric phenols, i.e. compounds having an average of more than one aromatic hydroxyl group per molecule such as, for example, dihydroxy phenols, biphenols, bisphenols, halogenated biphenols, halogenated bisphenols, alkylated biphenols alkylated bisphenols, trisphenols, phenol-aldehyde novolac resins, substituted phenol-aldehyde novolac resins, phenol-hydrocarbon resins, substituted phenol-hydrocarbon resins and any combination thereof. In another embodiment, the epoxy resin can be the reaction product of a polyepoxide and a compound containing more than one isocyanate moiety, a polyisocyanate.

Phenolic resins useful in the present invention include, for example, monohydric phenols and polyhydric phenols, i.e. compounds having an average of more than one aromatic hydroxyl group per molecule such as, for example, dihydroxy phenols, biphenols, bisphenols, halogenated biphenols, halogenated bisphenols, alkylated biphenols alkylated bisphenols, trisphenols, phenol-aldehyde novolac resins, substituted phenol-aldehyde novolac resins, phenol-hydrocarbon resins, substituted phenol-hydrocarbon resins, higher molecular weight phenolic resins, and any combination thereof.

For example, one preferred embodiment of the aromatic epoxy resin useful in the present invention may be a divinylarene dioxide. For example, the divinylarene dioxide such as a divinylbenzene dioxide (DVBDO) useful in the curable composition of the present invention is as described in U.S. patent application Ser. No. 13/133,510, incorporated herein by reference.

As one illustrative embodiment, and not be limited thereby, a divinylbenzene dioxide, a p-cresol, a cure catalyst, and other desirable and optional additives, can be admixed together to form the curable liquid carbon precursor composition. The optional additives can include for example, a second additional different epoxy resin other than the divinylbenzene dioxide; another phenolic resin; another cure catalyst; carbon black; carbon nanotubes; graphene; pitch-based precursor; tar-based precursor; and mixtures thereof.

For example, the optional second epoxy compound different from the above DVBDO may include one epoxy compound or may include a combination of two or more epoxy compound selected from a wide variety of epoxy compounds known in the art. For example, one or more epoxy compounds can be used in the composition such as epoxy compounds described in Pham, H. Q. and Marks, M. J., Epoxy Resins, the Kirk-Othmer Encyclopedia of Chemical Technology; John Wiley & Sons, Inc.: online Dec. 4, 2004 and in the references therein; in Lee, H. and Neville, K., Handbook of Epoxy Resins, McGraw-Hill Book Company, New York, 1967, Chapter 2, pages 2-1 to 2-33, and in the references therein; May, C. A. Ed., Epoxy Resins: Chemistry and Technology, Marcel Dekker Inc.: New York, 1988 and in the references therein; and in U.S. Pat. No. 3,117,099; all which are incorporated herein by reference.

The curable liquid carbon precursor composition of the present invention can include at least one curing agent compound; and the curing agent may include one curing agent or may include a combination of two or more curing agent compounds. The curing agent compound of the carbonized composition precursor useful in the present invention may be selected from any known curing agent (also referred to as a hardener or cross-linking agent) includes nitrogen-containing compounds such as amines and their derivatives; oxygen-containing compounds such as carboxylic acid terminated polyesters, anhydrides, phenol-formaldehyde resins, amino-formaldehyde resins, phenol, bisphenol A and cresol novolacs, phenolic-terminated epoxy resins; sulfur-containing compounds such as polysulfides, polymercaptans; and catalytic curing agents such tertiary amines, Lewis acids, Lewis bases and combinations of two or more of the above curing agents.

Other optional compounds that may be added to the curable liquid carbon precursor composition of the present invention may include compounds that are normally used in curable resin formulations known to those skilled in the art. For example, the optional components may comprise compounds that can be added to the composition to enhance application properties (e.g. surface tension modifiers or flow aids), reliability properties (e.g. adhesion promoters) the reaction rate, the selectivity of the reaction, and/or the catalyst lifetime.

Other optional compounds that may be added to the curable liquid carbon precursor composition of the present invention may include, for example, a curing catalyst, a solvent to lower the viscosity of the formulation further, other resins such as a phenolic resin that can be blended with the divinylarene dioxide resin of the formulation, other epoxy resins different from the divinylarene dioxide (i.e. aromatic and aliphatic glycidyl ethers, cycloaliphatic epoxy resins), other curing agents, fillers, pigments, toughening agents, flow modifiers, adhesion promoters, diluents, stabilizers, plasticizers, catalyst de-activators, flame retardants, or mixtures thereof.

As aforementioned, the curable liquid carbon precursor composition, in one preferred embodiment, has a low viscosity, for example a neat viscosity of less than about 10,000 mPa-s at 25° C. prior to adding any other optional components to the liquid precursor composition, prior to curing the liquid precursor composition, and prior to carbonizing the liquid precursor composition. In another embodiment, the curable liquid carbon precursor composition, prior to adding any optional compounds, prior to curing, and prior to carbonizing, generally has a neat viscosity of less than 10,000 mPa-s at 25° C.; from 1 mPa-s to 10,000 mPa-s in another embodiment, from 1 mPa-s to 5,000 mPa-s in yet another embodiment, from 5 mPa-s to 3,000 mPa-s in still another embodiment, and from 10 mPa-s to 1,000 mPa-s in yet another embodiment, at 25° C. In other embodiments, the neat viscosity of the curable liquid carbon precursor composition prior to curing can include 1 mPa-s or greater, 5 mPa-s or greater, or 10 mPa-s or greater. In other embodiments, the neat viscosity of the curable liquid carbon precursor composition prior to curing can include 10,000 mPa-s or lower, 5,000 mPa-s or lower, 3,000 mPa-s or lower or 1,000 mPa-s or lower. Still in other embodiments, the neat viscosity of the curable liquid carbon precursor composition can include less than about 10,000 mPa-s; less than about 1,000 mPa-s; less than about 500 mPa-s; less than about 300 mPa-s; less than about 100 mPa-s; and less than about 50 mPa-s at 25° C.

One advantage of the low viscosity property of the curable liquid carbon precursor composition is that the low viscosity enables a processable amount of resin pick-up by the carbon matrix such as carbon fibers.

As aforementioned, in another preferred embodiment, the curable liquid carbon precursor composition that has a neat viscosity of less than 10,000 mPa-s prior to adding any optional compounds, prior to curing, and prior to carbonizing, can provide a cured product having a high carbon yield (such as a carbon yield of about 35 wt. % or greater). The liquid carbon precursor composition, advantageously upon being cured, has a carbon yield of at least 35 wt. % as measured in the absence of optional components, for example by thermogravimetric analysis.

In addition to having a low viscosity, the curable liquid carbon precursor composition, prior to curing, has a surface tension that can be from about 10 mN/m to about 70 mN/m at 25° C. in one embodiment, from about 20 mN/m to about 60 mN/m in another embodiment, and from about 30 mN/m to about 60 mN/m in still another embodiment. In other embodiments, the surface tension of the curable liquid carbon precursor composition prior to curing can include about 10 mN/m or greater, about 20 mN/m or greater, or about 30 mN/m or greater. In still other embodiments, the surface tension of the curable liquid carbon precursor composition prior to curing can include about 70 mN/m or lower or about 60 mN/m or lower.

Furthermore, the curable liquid carbon precursor composition may have a wettability property sufficient to easily and efficiently wet the surface of a carbon substrate or member, that is, the liquid precursor has affinity between a liquid and a surface translating into the ability of the liquid to spread on the surface of the substrate.

Generally, the wetting ability, i.e. the wettability, of the curable liquid carbon precursor composition can be measured in terms of the contact angle of a droplet of the curable liquid carbon precursor composition reposed on top of a surface of a substrate. The contact angle can be a minimum of less than about 90 degrees, preferably from zero degrees to about 90 degrees, more preferably from about 5 degrees to about 90 degrees, even more preferably from 10 degrees to about 60 degrees, and most preferably from about 15 degrees to about 40 degrees at ambient temperature as measured on the surface of a substrate or a fiber in accordance to the method disclosed in ASTM Method D5725-99. In other embodiments, the contact angle of the curable liquid carbon precursor composition prior to curing can include about 0 degrees or greater, about 5 degrees or greater, 10 degrees or greater, or about 15 degrees or greater. In other embodiments, the contact angle of the curable liquid carbon precursor composition prior to curing can include 90 degrees or lower, 60 degrees or lower, or 40 degrees or lower.

The compounds used in making the curable liquid carbon precursor composition are beneficially low viscosity materials that mix without special effort. For example, the preparation of the curable liquid carbon precursor composition is easily achieved by blending the ingredients of the composition with a magnetic stir bar mixer or a pail mixer. For example, the curable liquid carbon precursor composition can be mixed with a standard pail mixer at from 1 rpm to 200 rpm.

As one illustrative embodiment, a curable liquid carbon precursor composition can be prepared by admixing together to form the liquid carbon precursor composition (A) at least one aromatic epoxy resin; and (B)(i) at least one aromatic co-reactive curing agent, (B)(ii) at least one catalytic curing agent, or (B)(iii) a mixture thereof.

The preparation of the curable liquid carbon precursor composition, and/or any of the steps thereof, may be a batch or a continuous process. The mixing equipment used in the process may be any vessel and ancillary equipment well known to those skilled in the art.

The required and optional components or ingredients of the curable liquid carbon precursor composition or formulation are typically mixed and dispersed at a temperature enabling the preparation of an effective curable liquid carbon precursor composition having the desired balance of properties for a particular application. For example, the temperature during the mixing of the components may be generally from about −10° C. to about 100° C. in one embodiment, and from about 0° C. to about 50° C. in another embodiment. Lower mixing temperatures help to minimize reaction of the resin and hardener components to maximize the pot life of the formulation.

The process of the present invention includes providing a fibrous or a porous carbon material adapted for being infused with the above liquid carbon precursor. The fibrous or porous carbon material useful in the present invention is also adapted to being further subjected to densification depending on the end use of the final product. The fibrous or porous carbon material useful in the present invention is also particularly amenable to being subjected to multiple chemical vapor infiltration (CVI) and/or multiple chemical vapor deposition (CVD) processing steps as a means for further densifying the carbon material.

The fibrous or porous carbon material useful in the present invention can include, for example, various woven/non-woven carbon fiber fabrics, and carbon preforms. For example, at least one fibrous preform made of carbon fiber or carbon fiber precursors can be used. These preforms may be made, for instance, of oxidized polyacrylonitrile fiber, stabilized pitch fiber, rayon fiber, or a combination of said fibers, and may be nonwoven preforms, needled fiber preforms, or random fiber preforms. In the present invention, multiple preforms may also be used.

In another embodiment, the carbon materials can include various carbon matrixes which are adapted to being infused with the curable aromatic epoxy resin liquid carbon precursor composition or formulation of the present invention may include, but is not limited to, carbon fibers, carbon block, graphite block, carbon fiber mats, any solid carbonaceous matrix and combinations thereof. The resin infused carbon matrix can then be subjected to carbonization to form a carbonized preform material for subsequent processing.

The present invention process for fabricating carbon-carbon composites includes the step of: (c) infusing a fibrous or a porous carbon material of step (b) with the liquid carbon precursor of step (a) to form a liquid carbon precursor-infused preform.

Some of the infusion techniques used for step (c) above can include, for example, conventional infusion, impregnation or infiltration processes such as resin transfer molding; vacuum assisted resin transfer molding; pressure assisted resin transfer molding; injection; vacuum pressure impregnation; pultrusion; dipping; rolling; spraying; brushing; soaking, wicking; pouring; and the like; or the combination of at least two or more of the above techniques.

The process conditions of the infusion step includes, for example, carrying out the step at a predetermined temperature and for a predetermined period of time sufficient to form a liquid carbon precursor-infused preform. For example, the temperature may be generally from about 0° C. to about 150° C. in one embodiment; from about 20° C. to about 120° C. in another embodiment; and from about 30° C. to about 70° C. in still another embodiment. Generally, the time may be chosen between about <1 minute to about >240 hours in one embodiment, between about 15 minutes to about 120 hours in another embodiment, and between about 30 minutes to about 48 hours in still another embodiment. Below a period of time of about 0.017 minutes, the time may be too short to ensure sufficient formation of the liquid carbon precursor-infused preform under conventional processing conditions; and above about 240 hours, the time may be too long to be practical or economical.

The present invention process for fabricating carbon-carbon composites includes the step of: (d) heating the liquid carbon precursor-infused preform of step (c) to form a carbon-carbon composite preform.

The process conditions of the step of forming a carbon-carbon composite preform includes, for example, carrying out the step at a predetermined temperature and for a predetermined period of time sufficient to form a carbon-carbon composite preform. For example, the temperature may be generally from about 80° C. to about 2000° C. in one embodiment; from about 100° C. to about 1500° C. in another embodiment; and from about 150° C. to about 1000° C. in still another embodiment. Generally, the time selected for heating to produce the carbon-carbon composite preform may be any time period including for example from about 1 minute up to several weeks depending the desired type of preform, and the size of the preform, i.e., shape and dimensions. In one embodiment, heating time may be carried out at a slow rate such that the period to form the carbon-carbon composite preform may take up to 3 weeks for example. In another embodiment, the heating time may be carried out at faster rate such that the period to form the carbon-carbon composite preform may take less than 3 weeks such as 60 hours or less for example. The process of preparing the carbon-carbon composite preform may be divided into steps for example, which may include a first step of curing the infused formulation and then the step of carbonizing the cured formulation.

The present invention process for fabricating carbon-carbon composites includes the step of: (e) increasing the density of the carbon-carbon composite preform of step (d) to form a carbon-carbon composite article.

The densification of the initial carbon-carbon composite preform produced in step (d) can be subjected to at least one cycle or multiple cycles of CVD or CVI to form a carbon-carbon composite article.

The step of densifying the composite can be carried out under conditions to provide the composite with a composite density of about 1.5 g/cc or greater in one embodiment, about 1.6 g/cc or greater in another embodiment, and about 1.7 g/cc or greater in still another embodiment. In another embodiment, the density of the composite can be from about 1.5 g/cc to about 2.0 g/cc

The densification of high temperature materials such as carbon-carbon composites and carbon fiber reinforced preforms is typically carried out using a CVD/CVI method of a carbon-carbon composite preform as well as any combinations of the above methods. CVI and CVD processes are known methods in the art. For example, CVD is the deposition onto a surface or substrate. In CVD, the substrate is exposed to one or more volatile precursors that react and/or decompose on the substrate surface to produce the desired deposit. CVI, on the other hand, implies deposition within a body, such as a porous preform. Besmann, T. M., Matlin, W. M., Stinton, D. P., “Chemical Vapor Infiltration Process Modeling and Optimization,” p 441-451 in Covalent Ceramics III: Non-Oxides, Vol. 410, eds. Barron, A. R. Fischman, G. S. Fury, M. A., Hepp, A. F., Materials Research Soc., Pittsburgh, Pa., 1996, define a CVI process and a CVD process, wherein a CVI process includes the chemical vapor deposition on the internal surfaces of a porous preform.

CVD is practiced in a variety of formats. These processes generally differ in the means by which chemical reactions are initiated. For example, CVD processes can be classified by pressure. Atmospheric pressure CVD (APCVD) is a CVD process conducted at atmospheric pressure. Low-pressure CVD (LPCVD) is a CVD process conducted at sub-atmospheric pressures. Reduced pressures tend to reduce unwanted gas-phase reactions and improve film uniformity across a substrate. Ultrahigh vacuum CVD (UHVCVD) is a CVD process conducted at very low pressure, typically below about 10⁻⁶ Pa. Most modern CVD processes are either LPCVD or UHVCVD.

CVD processes can also be classified by the physical characteristics of vapor. For example, aerosol assisted CVD (AACVD) is a CVD process in which precursors are transported to a substrate by means of a liquid/gas aerosol, which can be generated ultrasonically. This technique is suitable for use with non-volatile precursors. Direct liquid injection CVD (DLICVD) is a CVD process in which the precursors are in liquid form (liquid or solid dissolved in a convenient solvent). Liquid solutions are injected in a vaporization chamber towards injectors (typically car injectors). The precursor vapors are then transported to the substrate as in a classical CVD process. This technique is suitable for use on liquid or solid precursors. High growth rates can be reached using this technique.

CVD can also be performed using a plasma. For example, Plasma-Enhanced CVD (PECVD) is a CVD process that utilizes plasma to enhance chemical reaction rates of the precursors. PECVD processing allows deposition at lower temperatures, which is often critical in the manufacture of semiconductors. The lower temperatures also allow for the deposition of organic coatings, such as plasma polymers, that have been used for nanoparticle surface functionalization. Remote plasma-enhanced CVD (RPECVD) is similar to PECVD except that the substrate is not directly in the plasma discharge region. Removing the substrate from the plasma region allows processing temperatures down to room temperature.

Other examples include: Atomic layer CVD (ALCVD) which deposits successive layers of different substances to produce layered, crystalline films. Combustion Chemical Vapor Deposition (CCVD) (or flame pyrolysis) which is an open-atmosphere, flame-based technique for depositing high-quality thin films and nanomaterials. Hot wire CVD (HWCVD), also known as catalytic CVD (Cat-CVD) or hot filament CVD (HFCVD) is a process which uses a hot filament to chemically decompose the source gases. Hybrid Physical-Chemical Vapor Deposition (HPCVD) is a process which involves both chemical decomposition of precursor gas and vaporization of a solid source. Metalorganic chemical vapor deposition (MOCVD) is a CVD process based on metalorganic precursors. Rapid thermal CVD (RTCVD) is a CVD process which uses heating lamps or other methods to rapidly heat the wafer substrate. Heating only the substrate rather than the gas or chamber walls helps reduce unwanted gas-phase reactions that can lead to particle formation. Vapor phase epitaxy (VPE) is also a type of CVD process. Photo-initiated CVD (PICVD) uses UV light to stimulate chemical reactions. this process is similar to plasma processing, given that plasmas are strong emitters of UV radiation. Under certain conditions, PICVD can be operated at or near atmospheric pressure.

CVI processes are done similarly to CVD processes except that the chemical vapor is allowed to infiltrate within the pores of a substrate to modify the internal structure of the composite.

In the process of the present invention for producing carbon-carbon composites, the carbon-carbon composite preform starts with a low initial density (such as an initial density of 1.3 g/cc) and then the density of the carbon-carbon composite preform is increased (“densified”), i.e., the carbon-carbon composite preform is put through one or more series of “densification” steps sufficient to provide the appropriate density for the final carbon-carbon composite to be used in end use applications such as friction materials for brakes which require a high density (e.g. 1.5 g/cc or greater). Generally, the initial density of a carbon material can be increased at least about 5 percent or greater in one embodiment, 10 percent or greater in another embodiment, and 15 percent or greater in still another embodiment.

The perform can be prepared by several processes, including for example liquid infusion, resin transfer molding, injection molding, vacuum pressure impregnation, pultrusion, dipping, rolling, spraying, and brushing. A resin transfer molding (RTM) process involves the introduction of a liquid thermosetting resin into a matched-mold which contains a dry fiber preform. During the impregnation phase, an advancing resin front passing through the dry fiber preform wets the fiber and fills up the unoccupied volume of the preform with resin and the resin-impregnated reinforcement is allowed to cure prior to removing the part (Kendall et al., Composites Manufacturing 1992; Vol. 3, #4: p 235-249), incorporated herein by reference.

In a preferred embodiment, the step of forming a final carbon-carbon composite product or article includes carrying out the densification step utilizing a CVI and/or CVD processing technique.

The process conditions of the step of forming a final carbon-carbon composite product or article includes carrying out the densification step at a predetermined temperature and for a predetermined period of time sufficient to form a carbon-carbon composite. For example, the temperature may be generally from about 600° C. to about 3000° C. in one embodiment; from about 800° C. to about 2000° C. in another embodiment; and from about 900° C. to about 1500° C. in still another embodiment; and generally the time may be chosen between about 5 hours to about 200 hours in one embodiment, between about 50 hours to about 150 hours in another embodiment, and between about 80 hours to about 120 hours in still another embodiment. Below a period of time of about 5 hours, the time may be too short to ensure sufficient formation of the carbon-carbon composite under conventional processing conditions; and above about 200 hours, the time may be too long to be practical or economical.

The CVI and/or CVD processing steps can be performed before step (c) of infusing a material with the liquid carbon precursor to form a “green” carbon-carbon composite; after step (c), or in-between carrying out two or more liquid infusion steps (c).

Additionally, the present invention includes a process in which the chemical vapor infiltration process is used to densify a carbon-carbon composite preform made by the liquid infusion process.

In another embodiment, the present invention can include processes in which the preform is prepared by a resin transfer molding (RTM) process.

The present invention provides an advancement in the art by providing a process capable of rapidly densifying high temperature materials including carbon-carbon composites and carbon fiber-reinforced preforms.

As an illustrative example of the present invention, in one embodiment, step (e) can include performing a CVD on the cured and carbonized liquid carbon precursor-infused preform to form a carbon layer or matrix. In another embodiment, for example, step (e) can include performing a CVI on the cured and carbonized liquid carbon precursor-infused preform to form additional carbon within the composite matrix or layer.

Another embodiment of the present invention can includes a process for fabricating a carbon-carbon composite wherein a CVI may be performed on the carbon-carbon composite preform to form a more dense carbon-carbon composite preform; repeating CVI step until a desired density for the carbon-carbon composite preform is attained; and then optionally, subsequently performing a CVD step on the densified carbon-carbon composite preform to form a carbon-carbon composite with an increased density.

Still another embodiment of the present invention can include a process for fabricating a carbon-carbon composite wherein a CVI step may be performed on the carbon-carbon composite preform to form a more dense carbon-carbon composite; then repeating the CVI step until a desired density for the carbon-carbon composite preform is attained; then optionally, subsequently performing a liquid infusion on the CVI treated carbon-carbon composite in one cycle or in multiple cycles; and alternatively, optionally, performing a CVD step after the CVI treated carbon-carbon composite in one cycle or in multiple cycles.

Another embodiment of the present invention can include a process for fabricating a carbon-carbon composite using a combination of any one or more the CVI and/or CVD process steps described above in one cycle or in multiple cycles.

Still another embodiment of the present invention can include a process for fabricating a carbon-carbon composite wherein the steps of: (a) using a combination of any one or more the CVI and/or CVD process steps described above in one cycle or in multiple cycles; and then (b) repeating the processes of step (a) above to form a multi-layer carbon-carbon composite.

The resultant carbon-carbon composite article of the present invention advantageously exhibits a density of generally at least 1.5 g/cc. For example, the density of the carbon-carbon composite article generally may be from about 1.5 g/cc to 2.0 g/cc in one embodiment, from about 1.6 g/cc to about 2.0 g/cc in another embodiment, and from about 1.7 g/cc to about 2.0 g/cc in still another embodiment. Generally, the density of a carbon-carbon composite article is increased over the density of its preform by at least about 5 percent or greater in one embodiment, 10 percent or greater in another embodiment, and 15 percent or greater in still another embodiment.

The carbon-carbon composite product or article of the present invention may also be used to manufacture a wide variety of carbon products requiring a high carbon yield. For example, the carbon-carbon composite product or article of the present invention fabricated according to the process of the present invention can be used in the manufacture of fiber reinforced carbon-carbon composite parts such as automotive, train, and airplane brake pads and discs. The carbon-carbon composite brake discs are useful for example in such applications as aircraft landing systems, automotive breaking systems, and train braking systems.

In another embodiment, the curable liquid carbon precursor composition of the present invention may be used in other applications such as to manufacture composites for aerospace applications, electronic applications, and high temperature processes. For example, carbonized densified end products employing a carbon-carbon composite product of the present invention can include fuel cells, heat exchangers, carbon fibers, needle coke, graphite anodes, structural carbon-carbon composite articles or parts, and conductive carbon-carbon composite articles or parts.

### EXAMPLES

The following examples and comparative examples further illustrate the present invention in detail but are not to be construed to limit the scope thereof.

### Examples of the Fabrication of Carbon-Carbon Composites

### Example 1—Preparation of Preform

A liquid precursor is prepared in accordance with the procedure described in Example 1 of U.S. Provisional Patent Application Ser. No. 61/660,417 (Attorney Docket No. 72593). A carbon fabric is placed in a mold. An equal weight of the liquid precursor is poured onto the fabric and allowed to soak-in. Vacuum is applied to the mold to remove any entrapped air. The mold is then heated to cure the liquid precursor. The following cure schedule is applied:

| Temperature | Ramp Rate | Force | Soak time | Total Time |
|---|---|---|---|---|
| (° C.) | (° F./minute) | (lbs) | (minutes, hours) | (hours) |
| 135 | 1 | 100 | 300, 5 | 8.38 |
| (from RT*) | | (0.1 set-point) | | |
| 175 | 1 | 100 | 360, 6 | 7.2 |
| 185 | 1 | 100 | 240, 4 | 4.3 |
| 195 | 1 | 100 | 120, 2 | 2.3 |
| 24 | 4 | 100 | 1 | 1.31 |
| END | | | | 23.5 |

*RT = room temperature (about 25° C.)

After curing the liquid precursor in the mold as described above, the resulting green composite is then subjected to a post-cure cycle in a convection oven following the cure schedule below:

| Initial | Heating | Final | Hold | Total | Cumulative |
|---|---|---|---|---|---|
| Temperature | Rate | Temperature | Time | Time | Time |
| (° C.) | (° C./minute) | (° C.) | (hours) | (hours) | (hours) |
| 195 | 1 | 200 | 0.25 | 0.3 | 0.3 |
| 200 | 1 | 220 | 0.25 | 0.6 | 0.9 |
| 220 | 1 | 240 | 0.25 | 0.6 | 1.5 |

The post-cured green preform described above is then subjected to a pyrolysis treatment according to the schedule below:

| Initial | Heating | Final | Hold | Total | Cumulative |
|---|---|---|---|---|---|
| Temperature | Rate | Temperature | Time | Time | Time |
| (° C.) | (° C./minute) | (° C.) | (hours) | (hours) | (hours) |
| 30 | 0.48 | 350 | 3 | 14.1 | 14.1 |
| 350 | 0.63 | 500 | 6 | 10 | 24.1 |
| 500 | 0.35 | 1000 | 2 | 25.8 | 49.9 |

### Example 2—Chemical Vapor Infiltration

The preform of Example 1 is subjected to a CVI process as disclosed herein in Embodiments 1 to 3. The CVI process used in the following Embodiments 1 to 3 are carried out as described in Experimental Example 2 of U.S. Pat. No. 6,197,374:

### Embodiment 1

Processes for the chemical vapor infiltration of refractory substances such as carbon (C) or silicon carbon (SiC) are mainly used in the production of fiber-reinforced composite materials (also referred to in the English literature as ceramic matrix composites [CMC]). A preferred embodiment of the present invention for the production of a carbon-fiber-reinforced carbon by chemical vapor infiltration of carbon in a carbon fiber structure is described as follows:

Felt is used as the carbon fiber structure in this Embodiment 1. The structure has a diameter of 36.5 mm and a thickness of 20 mm, corresponding to a volume of about 19 cm³. The initial weight of the structure is 3.8 g. In assuming a density about 1.8 g/cm³ for the carbon fibers, the fibers have a volume of about 2 cm³. The free pore volume of the structure prior to infiltration is thereby about 17 cm³.

The infiltration of resin in the carbon fiber structure is carried out as follows:

A total pressure (Pₜₒₜₐₗ) of 20 kPa, a temperature (T) of 1,100° C., and a persistence time of the gas in the reaction zone (τ) of 0.33 seconds is used this Embodiment 1. The gas used is a mixture of methane (CH₄) and hydrogen (H₂) in a molar ratio of 7 to 1. The conditions are adjusted such that as complete an infiltration as possible is achieved in an acceptable amount of time. Under these conditions about 10% of the carbon which is added with the educt gas methane is deposited in the porous structure. The integration of the fiber structure in the reactor is achieved with the help of a special mounting of two cm thickness. Between the special mounting and the side retaining borders is an aperture of 2 mm width.

After 6 days of continuous infiltration, the infiltrated fiber structure has a weight of 36.1 g. Taking into account the density of the deposited carbon of 2.07 g/cm³, a degree of pore filling of over 92% or a remaining porosity of less than 8%, is found. The medium density is 1.9 g/cm³. Under no circumstances can similar results be achieved with procedures previously known in the art, even after a week-or month-long infiltration. Process known in the state of the art, include the added difficulty of having to interrupt the infiltration step in the process several times in order to mechanically clean the surfaces of the equipment used.

### Embodiment 2

An infiltration of carbon with technically pure methane is carried out. The total pressure is 20 kPa, the temperature is 1,100° C., and the persistence time is adjusted to 0.16 seconds. The porous structure is subjected to a gas flow applied through apertures of 2 mm width. Widths of apertures smaller than 50 mm yield usable pore fillings under high pressures in the region of saturation adsorption according to the disclosure in U.S. Pat. No. 6,197,374 B1. By using aperture widths of less than 25 mm, pore fillings in the region of saturation adsorption are achieved, which are better than the pore fillings attainable through common processes, with the high pressures according to the disclosure U.S. Pat. No. 6,197,374 B1. Best results are achieved with regard to pore filling and production speed in a region of from 1 mm to 5 mm, as seen in the present embodiments. The widths of the apertures are chosen to be larger than 1 mm in order to facilitate isobaric pressure conditions with short persistence times. Insofar as isobaric pressure conditions can be achieved with narrower aperture widths, these can be smaller than 1 mm.

### Embodiment 3

In this Embodiment 3, the following infiltration conditions are maintained:

Temperature (T)=1,100° C.

Total pressure (Pₜₒₜₐₗ)=26 kPa to 100 kPa.

Gas flow with pure methane.

Persistence time (τ)=0.16 second.

### Example 3—Chemical Vapor Deposition

The composite of Example 1 above is subjected to a CVD process as disclosed herein in this Example 3. The CVD process used in this Example 3 is carried out as described in Example 1 of U.S. Patent Application Publication No. 20120328884 A1 as follows:

An n-type silicon substrate, which has mirror-polished face, is subjected to ultrasonic treatment in a solution having diamond powders that have a size of about 1 nm for 30 minutes, and is ultrasonically cleaned using acetone so as to remove residual particles on the substrate.

Then, the substrate is disposed in a microwave plasma enhanced chemical vapor deposition (MPECVD) system, in which the ratio of the CH₄ flowing rate (in unit of sccm) to argon (Ar) flowing rate (in unit of sccm) is 4:196 (i.e., the volume percentage of CH₄ is 2%). Thereafter, the MPECVD process is conducted in the system for 60 minutes to form a seeding layer on the mirror-polished face of the silicon substrate. The seeding layer includes an amorphous carbon matrix, and a plurality of ultra-nanocrystalline diamond (UNCD) grains dispersed in the amorphous carbon matrix.

Next, H₂ is introduced into the MPECVD system so that CH₄, H₂, and Ar are in a volume ratio of 1:49:50. Then, the MPECVD process is conducted for 30 minutes under a working pressure of ˜7333 Pa to grow crystal grains on the seeding layer. A carbon-based composite material is obtained.

### Example 4

The composite from Example 2 above is subjected to a CVD process as described in Example 3 above.

What is claimed is:

1. A process for fabricating a carbon-carbon composite article comprising the steps of:
(a) providing a liquid carbon precursor composition; wherein the liquid precursor composition has a neat viscosity of less than about 10,000 mPa-s at 25° C. prior to adding optional components, prior to curing, and prior to carbonizing; and wherein the liquid precursor composition being cured has a carbon yield of at least about 35 weight percent as measured in the absence of optional components;
(b) providing a fibrous or a porous carbon material adapted for being infused with the liquid carbon precursor composition of step (a);
(c) infusing the fibrous or porous carbon material of step (b), at least one time, with the liquid carbon precursor composition of step (a) to form a liquid carbon precursor-infused preform;
(d) heating the liquid carbon precursor-infused preform of step (c) to form a carbon-carbon composite preform; and
(e) increasing the density of the carbon-carbon composite preform of step (d) to form a carbon-carbon composite article.

2. The process of claim 1, wherein step (e) is carried out by chemical vapor deposition, chemical vapor infiltration; or a combination of chemical vapor deposition and chemical vapor infiltration.

3. The process of claim 1, wherein the density of the carbon-carbon composite preform in step (e) is increased at least about 5 percent or greater.

4. The process of claim 1, wherein step (d) is carried out by first curing the liquid carbon precursor-infused preform and subsequently carbonizing the cured carbon precursor-infused preform to form a carbon-carbon composite preform.

5. The process of claim 1, wherein the process is carried out solvent-free.

6. The process of claim 1, wherein step (d) is carried out a temperature from about 80° C. to about 2000° C.

7. The process of claim 1, wherein the fibrous or porous carbon material comprises carbon fiber.

8. The process of claim 1, wherein curable liquid carbon precursor composition comprises a combination of: (A) at least one aromatic epoxy resin; and (B)(i) at least one aromatic co-reactive curing agent, or (B)(ii) at least one catalytic curing agent, or (B)(iii) a mixture thereof.

9. The process of claim 8, wherein the at least one aromatic epoxy resin comprises a divinylarene dioxide and wherein the divinylarene dioxide comprises divinylbenzene dioxide.

10. The process of claim 1, wherein the curable liquid carbon precursor composition is solvent-free.

11. The process of claim 1, wherein the density of the carbon-carbon composite is from about from about 1.5 g/cc to about 2.0 g/cc.
